(19) United States
(12) Patent Application Publication
(10) Pub. No.: US 2014/0259670 A1
(43) Pub. Date: Sep. 18, 2014

(54) Human-Machine Interface Mechanism For Automated Wheel Production

(71) Applicant: FACTORY AUTOMATION TECHNOLOGY CO., LTD., (US)

(72) Inventors: HSIN HUNG HOU, Chiayi County (TW); PO CHENG SU, Chiayi County (TW)

(73) Assignee: FACTORY AUTOMATION TECHNOLOGY CO., LTD., Chiayi County (TW)

(21) Appl. No.: 13/846,561

(22) Filed: Mar. 18, 2013

(51) Int. Cl. B23D 36/00

(52) U.S. Cl. CPC B23D 36/00
USPC 29/894.3

(57) ABSTRACT

A human-machine interface mechanism for automated wheel production, which electrically connects with a mechanical arm and a machine tool, wherein the human-machine interface mechanism for automated wheel production includes a human-machine interface device for identifying the wheel type of a wheel billet and locating the manufacturing position, so that the wheel billet is gripped by the mechanical arm and transferred to the machine tool for manufacturing. The human-machine interface device includes a display operation unit, an imaging unit, at least one optical illumination unit, a servomotor unit, an I/O unit, and a control unit. The human-machine interface mechanism for automated wheel production not only determinates and locates more quickly and accurately, but also improves manufacturing precision.

### BACKGROUND OF THE PRESENT INVENTION

1. Field of Invention

The present invention relates to a human-machine interface mechanism for automated wheel production, and more particular to a human-machine interface mechanism which operates on a display operation unit and identifies the wheel type of a wheel billet by distinguishing the image of the wheel billet, which is obtained by using a camera unit and optical illumination unit, and drives a servomotor unit to locate a manufacturing position by rotating the wheel billet, all of which is performed through an integrated operation of the human-machine interface device.

2. Description of Related Arts

At present, the traditional processing method of a wheel contains three procedures: the 1^{st} Operation Procedure (OP1), the 2^{nd} Operation Procedure (OP2), and the 3^{rd} Operation Procedure (OP3) (referring to China Taiwan patent NO. I369301, Processing Method of Wheel Rim). Before machining the wheel billet by a machine tool, the machine tool depends on laser detector for space and location identification, but the operation for space and location identification is complicated and the time to process the space and location identification is time consuming. The operator detects the wheel billet by eye and rotates the wheel billet to a processing position thereof, which expends labor and time and affects the quality of processing.

Referring to China Taiwan patent NO. I225578, Machining System, which discloses a machining system for machining different kinds of work pieces which includes: a machine tool for machining the work piece, a mechanical arm for transferring the work piece, a visual sensor for detecting the work piece, an information processing device connected with the machine tool, the mechanical arm and the visual sensor through a communication path, the information processing device which includes display means for displaying a list of items specifying operation programs for the machine tool, the mechanical arm or the visual sensor to be used for different kind of work pieces on a display screen, and a communicating means for uploading/downloading an operation program specified by one of the items displayed on the display screen selected by an operator and/or information associated with the operation program from/to the machine tool or the mechanical arm and the visual sensor, wherein the operation program and/or the associated information specified by the item selected by the operator to confirm and edit the displayed operation program and/or associated information.

In the above described machining method, the work piece, through the visual sensor connected with the mechanical arm, is operated by an operator selected operation program or information associated with the operation program specified by one of the items displayed on the display screen to process the machining program by the machine tool. The computing of the machining method is complex, and the visual sensor connected with the mechanical arm in cooperation with the information processing device needs precise operating so as to achieve the machining precision of the work piece.

Therefore, the inventor studiously researched and developed the present invention. The present invention precisely locates and operates easily during manufacturing so that increase product quality and precision.

### SUMMARY OF THE PRESENT INVENTION

The invention is advantageous in that it provides a human-machine interface mechanism for automated wheel production that precisely positions and conveniently operates during manufacturing so that increases the product quality and precision.

To achieve the above objects, the present invention provides a human-machine interface mechanism for automated wheel production, which electrically connects with a mechanical arm and a machine tool; the human-machine interface mechanism for automated wheel production comprises: a human-machine interface device for identifying the wheel type of a wheel billet and locating the manufacturing position, wherein the wheel billet is gripped and transferred to the machine tool for manufacturing by the mechanical arm. The human-machine interface comprises a display operation unit, an imaging unit, at least one optical illumination units, a servomotor unit, an I/O unit, and a control unit.

In an embodiment of the present invention, the optical illumination units are laterally fixed under the imaging unit.

In an embodiment of the present invention, the inner edge of the wheel billet provides a locating position.

In an embodiment of the present invention, the control unit has an output voltage terminal for supplying 24 volts of DC voltage, wherein the I/O unit connects with the output voltage terminal of the control unit and receives the 24 volts of DC voltage supplied by the output voltage terminal of the control unit and converts the 24 volts of DC voltage to 5 volts into DC voltage.

In an embodiment of the present invention, the human-machine interface device is fixed on a feed conveyor.

In an embodiment of the present invention, the human-machine interface device electrically connects with an analogy unit.

In an embodiment of the present invention, the human-machine interface device is fixed on a feed conveyor and a discharge conveyor respectively.

The human-machine interface for automated wheel production of the present invention precisely locates and easily operates during manufacturing so as to increase the product quality and precision.

### BRIEF DESCRIPTION OF THE DRAWINGS

FIG. 1 is block diagram of a human-machine interface for an automated wheel production mechanism according to a preferred embodiment of the present invention.

FIG. 2 is a flow chart for manufacturing a wheel with a human-machine interface mechanism for automated wheel production according to the above preferred embodiment of the present invention.

FIG. 3 is a schematic diagram illustrating the display operator unit showing user interface according to the human-machine interface mechanism for wheel automated production according to the above preferred embodiment of the present invention.

FIG. 4 is a schematic diagram illustrating the display operator unit showing the user interface of wheel billet according to the human-machine interface mechanism for automated wheel production according to the above preferred embodiment of the present invention.

FIG. 5 is a schematic diagram illustrating the wheel billet imaging and fill light according to the human-machine interface mechanism for automated wheel production according to the above preferred embodiment of the present invention.

FIG. 6 is a schematic diagram illustrating the wheel being rotated from a locating position to a manufacturing position through a servomotor according to the above preferred embodiment of the present invention.

FIG. 7 is a flow chart illustrating wheel manufacturing according to another embodiment of the present invention.

FIG. 8 is a block diagram according to another embodiment of the present invention.

### DETAILED DESCRIPTION OF THE PREFERRED EMBODIMENT

To disclose the present invention more complete and clear, hereby describes specifically in the following.

Referring to FIG. 1, a block diagram of a preferred embodiment of the present invention is illustrated. The human-machine interface mechanism for automated wheel production comprises a human-machine interface device 1, which further comprises a display operation unit 11, an imagining unit 12, at least one optical illumination unit 13, a servomotor unit 14, an I/O unit 15, and a control unit 16; wherein the human-machine interface device 1 electrically connects with a mechanical arm 3 and a machine tool 4.

In the present invention, the human-machine interface device 1 is a device working on a human-machine interface computer, which has the display operation unit 11 for configuring operation, the control unit 16 for driving the machine tool 4, the mechanical arm 3 and the servomotor unit 14 powered by 24 volts converted by the I/O unit 15, and the control unit 16 for driving the imaging unit 12, the optical illumination unit 13, and human-machine computer powered by 5 volts converted by the I/O unit 15.

Referring to FIG. 2, the process of automated wheel production by using the human-machine interface mechanism for automated wheel production is the following: a wheel billet is transferred to the imaging unit 12 and the optical illumination unit 13 of the human-machine interface device 1 by the feed conveyor 5, the human-machine computer drives the imaging unit 12 and the optical illumination unit 13 to capture a image of the wheel type to identify the wheel type and obtain the position information of the locating position, and then the associated information is transferred to the human-machine computer for determination. After this determination, the wheel billet is rotated to the manufacturing position through the servomotor unit 14. When the preceding steps are completed, the human-machine computer drives the mechanical arm to grip the wheel billet for processing each of the machine tool manufacturing procedure, OP1/PCD/OP2. (the machine tool processes each of manufacturing procedures in accordance with the determination by the human-machine computer).

Referring to FIG. 2˜FIG. 4, the display control unit 11 of the human-machine interface device 1 comprises a user interface and a plurality of touch keys. The touch keys are capable of changing to different operations in accordance with the configuration of different functional sub user interface so as to facilitate the operator to configure operation (as shown in FIG. 3). The locating position is arranged in respect to the inner edge of the wheel billet, wherein the locating position may apply optical coatings so as to provide easy identification for the imaging unit. Before the wheel billet is transferred to the 1^{st} Operation Procedure (OP1) through the feed conveyor, the mechanical arm 3 grips and fixes the wheel billet. The wheel billet is adjusted to the appropriate focal length of the camera of the imagine processing unit 12 through the power cylinder fixed under the wheel billet (not shown in figure) and the lifting of the servomotor unit 14. At this time, through the optical illumination unit 13, such as LED light source, is fixed laterally and located under the imaging unit 12 which illuminates laterally inward and fill light, so as to obtain the wheel billet image of the edge with acute angle line 22 and the inner edge with locating position 21 (as shown in FIG. 4˜FIG. 5).

As shown in FIG. 1˜FIG. 6, the imaging unit 12 of the human-machine device 1, such as a CCD camera, obtains the dimensions of wheel type of the wheel billet, the spokes shape of the wheel billet, and the locating position of the wheel billet for processing operation, identification, and comparison. After the operator saves the configuration on the display operation unit 11, the servomotor unit 14 of the human-machine interface device 1 begins to rotate the wheel billet to locate the position of the inner edge of the wheel billet for the manufacturing position 211 of the machine tool 4. The human-machine interface device 1 makes the mechanical arm grip the wheel billet to the machine tool 4 of the 1^{st} Operation Procedure (OP1) for manufacturing.

The control unit 16 of the human-machine interface device 1 supplies 24 volts of DC voltages for industrial tools. Through the voltage conversion of the I/O unit 15, 24 volts of DC voltage is capable of converting into 5 volts of DC voltage for supplying the electrical assembly of the human-machine interface device 1.

Therefore, after operating and identifying the wheel type data of the wheel billet 2 obtained by the imaging unit 12, through the control unit 16, the I/O unit 15 converts power and supplies to the servomotor unit 14 of the human-machine interface device 1. The human-machine interface device 1 drives the servomotor unit 14 to rotate the wheel billet to the manufacturing position 211 of the machine tool 4. The human-machine interface device 1 drives the mechanical arm to grip the wheel billet from the feed conveyor 5 and places in the machine tool 4 for manufacturing the inner and outer diameter of the wheel billet of the 1^{st} Operation Procedure (OP1). When the OP1 is finished, the human-machine interface device 1 makes the mechanical arm remove the wheel billet and places in the machine tool 4 for the Pitch Circle Diameter (PCD) procedure for manufacturing a PCD hole, and then turns the wheel billet over to manufacture a gas nozzle hole in manufacturing position 211. After the manufacturing of the gas nozzle hole is complete, the human-machine interface device 1 makes the mechanical arm remove the wheel billet 2 and places in the 2^{nd} Operation Procedure (OP2) for manufacturing wheel disc. When the OP2 is finished, the mechanical arm removes the wheel product and moves to a discharge conveyor 6 and all the procedures are complete. According to the wheel image data operated and distinguished by the human-machine interface device 1, the machine tool 4 of each procedure performs each manufacturing procedure.

The imaging unit 12 of the human-machine interface device 1, such as a CCD camera, may obtain the image information about the wheel type appearance, number of spokes, the number of manufacturing holes, the position of each manufacturing hole, and locating position 21. The human-machine interface device 1 performs the operation based on the circular of wheel type, and through image preprocessing techniques such as gray scale statistic, thresholding, dimensions correcting, sub-pixels, linear regression, and image size measurement, so that the operation speed is improved. The purpose of the program is that when the wheel image is processed through processing techniques such as image segmentation, image enhancement, image denoising, connection analysis, thinning, broken-line linking, extracting parameters in accordance with the wheel appearance, the edge of the wheel, the lines of the wheel, and the structure characteristics of the wheel are identified and determined in accordance with methods such as graphic comparison, neural network, moment invariants, etc. Finally, the identification results are outputted and the processing wheel image is complete. When the image of wheel billet is captured by imagine unit 12 through the optical illumination unit 13, fixed laterally under the imaging unit 12, it illuminates average and fill light for obtaining a clearer image of the edge of the wheel billet 2 with acute angle line 22 and the inner edge with the locating position 21, so that the wheel type, the spokes, and manufacturing position 211 for manufacturing the gas nozzle becomes clearer. The human-machine interface device 1 identifies more precision in the system operation and analysis. Then the human-machine interface device integrates the manufacturing information, and makes the mechanical arm 3 and machine tool 4 perform the manufacturing.

Referring to FIG. 5˜FIG. 6, the human-machine interface device 1 is capable of directly transmitting and driving the servomotor unit 14 to rotate the inner edge of wheel billet 2 from the locating position 21 to the manufacturing position 221 for manufacturing by the machine tools and to make the mechanical arm 3 grip the wheel billet from the feed conveyor 5 for processing the 1^{st} Operation Procedure of wheel manufacturing. Simultaneously, the human-machine interface device 1 operation and communication immediately drives the servomotor unit 14 to achieve the precise position of the manufacturing position 211 by rotating without additional motion controllers or programmable logic controller (PLC) devices.

Referring to FIG. 7, another embodiment of the present invention is illustrated. A human-machine interface device 1 is arranged to the feed conveyor 5 for detecting the manufacturing dimension of the wheel type, wheel appearance, and locating the locating position 211. The human-machine interface device 1 for automated wheel production is suitable for being arranged with another human-machine interface device 7 to the discharge conveyor 6 after the 2^{nd} operation procedure of wheel manufacturing is finished. After 2^{nd} operation procedure finished, the mechanical arm 3 grips the wheel product to the discharge conveyor 6 and the imaging unit 12 and the optical illumination unit 13 of the human-machine interface device 7 inspects the wheel product. Any failed product is detected and recorded immediately by the human-machine interface device 7, so that each wheel is inspected quickly and manufactured correctly. This inspection reduces the manufacturing time and improves the manufacturing quality and precision of the wheel product.

Referring to FIG. 8, another embodiment of present invention is illustrated. The human-machine interface device 1 connects with an analogy unit 8. During the manufacturing of the wheel billet 2, the human-machine interface device 1 is capable of simulated learning, and can call the manufacturing operation anytime, so as achieve the convenience of automated manufacturing.

One skilled in the art will understand that the embodiment of the present invention as shown in the drawings and described above is exemplary only and not intended to be limiting.

It will thus be seen that the objects of the present invention have been fully and effectively accomplished. It embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A human-machine interface mechanism for automated wheel production electrically connects with a mechanical arm and a machine tool, said human-machine interface mechanism for automated wheel production comprises at least a human-machine interface device for identifying a wheel type of a wheel billet and locating the position of a manufacturing position, wherein said human-machine interface device comprises a display operation unit, an imagine unit, at least one optical illumination unit, an I/O unit, and a control unit.

2. The human-machine interface mechanism for automated wheel production, as recited in claim 1, wherein said optical illumination unit is laterally fixed under said imaging unit.

3. The human-machine interface mechanism for automated wheel production, as recited in claim 1, wherein the inner edge of said image unit provides a locating position.

4. The human-machine interface mechanism for automated wheel production, as recited in claim 1, wherein said control unit has an output voltage terminal for supplying a DC voltage of 24 volts, said I/O unit connects with said output voltage terminal of said control unit and receives said DC voltage of 24 volts supplied by said output voltage terminal of said control unit and converts said DC voltage of 24 volts into a DC voltage of 5 volts.

5. The human-machine interface mechanism for automated wheel production, as recited in claim 1, wherein said human-machine interface device is arranged to a feed conveyor.

6. The human-machine interface mechanism for automated wheel production, as recited in claim 1, wherein said human-machine interface device electrically connects with an analogy unit.

7. The human-machine interface mechanism for automated wheel production, as recited in claim 1, wherein said human-machine interface is arranged to said feed conveyor and another said human-machine interface is arranged to a discharge conveyor.

8. A method of the automated wheel production for a human-machine interface mechanism, comprising the steps of:
(a) transferring an image of a wheel billet to an imagine unit and at least one optical unit of a human-machine interface device;
(b) capturing an image of the wheel billet;
(c) identifying a wheel type of said wheel billet from said image of said wheel billet;
(d) rotating said wheel billet to a manufacturing position; and
(e) processing said manufacturing procedure of each the machine tool.

9. A method of the automated wheel production for a human-machine interface mechanism, as recited in claim 8, wherein said optical illumination unit is fixed under said imaging unit for illuminating towards said wheel billet so as to obtain said image of said wheel billet.

10. A method of the automated wheel production for a human-machine interface mechanism, as recited in claim 8, wherein said wheel billet provides a locating position.

11. A method of the automated wheel production for a human-machine interface mechanism, as recited in claim 9, wherein the step (b) further comprises a step of adjusting the focal length to capture said image of said wheel billet.

12. A method of the automated wheel production for a human-machine interface mechanism, as recited in claim 11, wherein the adjusting of said focal length through adjusting said wheel billet and said image unit through the lifting of a servomotor unit.

13. A method of the automated wheel production for a human-machine interface mechanism, as recited in claim 9, wherein the step (b) further comprises a step of illuminating average towards said wheel billet and fill light, so that obtaining said image of said wheel billet of the edge with an acute angle line and the inner edge with said locating position.

14. A method of the automated wheel production for a human-machine interface mechanism, as recited in claim 11, wherein the step (b) further comprises a step of illuminating average towards said wheel billet and fill light, so that obtaining said image of the wheel billet of said edge with said acute angle line and said inner edge with said locating position.

15. A method of the automated wheel production for a human-machine interface mechanism, as recited in claim 10, wherein the step (a) further comprises a step of applying an optical coating on said locating position of said wheel billet.

16. A method of the automated wheel production for a human-machine interface mechanism, as recited in claim 13, wherein the step (c) further comprises the steps of:
(c.1) preprocessing said image of said wheel billet for improving operation speed;
(c.2) processing said image of said wheel billet;
(c.3) extracting parameters of said image of said wheel billet;
(c.4) identifying the wheel type of said wheel billet; and
(c.5) outputting the identification result.

17. The method as recited in claim 14, wherein the step (c) further comprises the steps of:
(c.1) preprocessing said image of said wheel billet for improving operation speed;
(c.2) processing said image of said wheel billet;
(c.3) extracting parameters of said image of said wheel billet;
(c.4) identifying said wheel type of said wheel billet; and
(c.5) outputting said identification result.

18. A method of the automated wheel production for a human-machine interface mechanism, as recited in claim 16, wherein the step (d) further comprising a step of converting and supplying said power to a servomotor unit for driving said servomotor unit to rotate said wheel billet to said manufacturing position.

19. A method of the automated wheel production for a human-machine interface mechanism, as recited in claim 17, wherein the step (d) further comprising a step of converting and supplying said power to a servomotor unit for driving said servomotor unit to rotate said wheel billet to said manufacturing position.

20. A method of the automated wheel production for a human-machine interface mechanism, as recited in claim 8, wherein said human-machine interface device connects with an analogy unit for simulated learning by itself and calling manufacturing operation.
